(19) United States
(12) Patent Application Publication
(10) Pub. No.: US 2024/0012944 A1
(43) Pub. Date: Jan. 11, 2024

(54) SYSTEM AND METHOD FOR AUTHENTICATING CERTIFICATES USING NFTS

(71) Applicant: MEIRAV HAREL, MOSHAV RAMAT RAZIEL (IL)

(72) Inventor: MEIRAV HAREL, MOSHAV RAMAT RAZIEL (IL)

(21) Appl. No.: 18/218,205

(22) Filed: Jul. 5, 2023

Related U.S. Application Data
(60) Provisional application No. 63/358,405, filed on Jul. 5, 2022.

(51) Int. Cl. G06F 21/64; G06Q 20/36; H04L 9/00

(52) U.S. Cl. CPC G06F 21/64; G06Q 20/36; H04L 9/50

(57) ABSTRACT

Authenticating certificates using NFT smart contract blockchain technology and NFTs, smart contracts, and blockchain infrastructure combined with elements of NFT marketplaces to enable authenticating certification and documentation, individual data collection, and individual monetization for such certificates.

### CROSS-REFERENCE TO RELATED APPLICATIONS

This application claims the benefit of priority of U.S. Provisional Patent Application No. 63/358,405, filed Jul. 5, 2022, the contents of which are incorporated herein by reference in their entirety.

### FIELD

The invention relates generally to authentication of certifications, and more particularly to authentication of certifications using blockchain tools such as non-fungible tokens (NFTs).

### BACKGROUND

Documents and certificates may be considered the backbone of society and may be used to assess an entity's background, abilities, assets etc. Today, the ability to authenticate such certificates is somewhat limited, and according to some reports, there may be a growing global crisis created by a fake certification and documentation industry.

In the academic field for instance, some reports assess that the number of genuinely awarded PhD degrees in the United States is estimated to be between 40,000 to 45,000 each year, while the number of fake PhDs bought each year from diploma “mills” is estimated to exceed 50,000 each year. In other words, more than half of all people claiming a new PhD from a US college may in fact be presenting a fake degree.

The impact of such fake degrees may devalue legitimate degrees that people spend several years of their lives and hundreds of thousands of dollars earning. More importantly, fake certificates used for those who lack the proper skills and expertise to enter professions like engineers and health-care workers, may put lives at risk.

Further, certifications may often be provided by different issuers, so that authenticating the certification may require lots of work and investment in time, potentially including contacting multiple issuers, complicated by the difficulty in finding the issuer and even the correct person or group within the issuer as well as the costs of the authentication process.

Similar risks and potential for fraud takes place in the other fields where certificates, certifications, and related types of documents (all hereinafter referred to as “certificates” or “certifications”) are provided and a system and method to provide authentication for such certificates is therefore desirable. The need to authenticate information becomes even more necessary when using artificial intelligence (AI) tools as these may rely on unauthenticated data and certifications to thus spread false information.

In addition, data that is collected about people through such certificates, may not enable the people named on the certificates to monetize the collected data, or even own the data collected about them, or even know where their data is being used and transferred to. Therefore, a system and method to provide authentication, individual data collection, and individual monetization for such certificates may be desirable.

### SUMMARY

The invention, in embodiments thereof, presents various systems and methods for authenticating, owning, and monetizing certifications using NFT and/or smart-contract blockchain technology to create an eco-system of “authenticated NFT certifications” (herein referred to as authenticated NFTCs or simply NFTCs). This solution may use NFTs and blockchain infrastructure, smart contracts, combined with elements of NFT marketplaces that may enable authenticating certificates as explained below.

The invention may be relevant for enabling authentication, ownership and monetization of certificates in various areas/fields including but not limited to: academic diplomas, academic courses, professional certification, letters of recommendation by employers, professional work certificates, volunteer certificates (that prove that a person really volunteered), medical certificates, medical history (such as but not limited to keeping track of vaccination status, MRI results etc.), gender identity, ISO certification, guaranties and warranties of products and services, receipts (such as but not limited to receipts needed for proof of expenses, proof of donations, and so forth such as for tax purposes), certificates of company registration and ownership, usage of trademarks on websites with authorization from the trademark owner, kosher certification, KYC (know your customer) for financial services, financial bank documents and statements, bank cheques, insurance documents including insurance policies and appraiser reports, legal documentation (such as but not limited to wills, pre-nuptial agreements, legal agreements, court orders, rulings, legislation and so forth), notarized legal documents, marriage certificates, divorce certificates, patent certificates, patent assignments, patent documentation, of patent status (such as but not limited to authenticating patent pending status), certifying that data belongs to an entity, appraisals, (such as but not limited to real estate appraisals, or appraisals of damage to cars after an accident), official government documentation, official professional documentation, and so forth.

It is anticipated that use of the invention may create a new norm for authenticating certificates, individual authenticated certificates and data collection, and individual monetization of the above, including for certificates created by academic institutions, professional bodies, training organizations, legal, financial, medical and in the areas listed above. The invention may utilize NFT and/or smart-contract blockchain technology in the above fields to issue new authenticated NFT certificates. Additionally or alternatively, the invention may utilize NFT and/or smart contract blockchain technology in the above fields to issue authenticated NFT certificate versions of previously issued “non-authenticated” certificates. In some embodiments, the system may provide a link (such as a URL) to an authenticated NFT certificate such as on websites, social media, written materials, and so forth. For example: on a resume or on LinkedIn, for an authenticated diploma.

In some embodiments, the system as disclosed may provide an authenticated source wallet distribution protocol such that wallets held by issuers may be trusted to be authentic wallets of the issuers.

In some embodiments, the certified documents maybe kept in designated blockchain based wallets, held by the certificate holders (receivers) after they have been transferred from the issuer wallet, and/or also held by the certifiers. In some embodiments, for certificate holders, there may be multiple digital wallets that hold the certificates owned by the holder, for instance arranged—per certificate field subject, such as a medical wallet for NFTs of medical documentation, an academic wallet for academic documentation, insurance wallet, financial wallet, professional wallet, legal wallet and so forth). As used herein, the terms “user profile” or “holder profile” may refer to a “digital wallet” or multiple digital wallets that hold the holders authenticated certificates. In some embodiments, users (holders) and\or issuers may decide who and how their profiles (wallets) can be used, and at what fee or royalties for the viewer. For example, Holders or issuers may decide:
1. Who to allow to view their various wallets (via a link for example).
2. To enable viewers to find them when viewers search according to characteristics and certificates.
3. In some embodiments, holders or issuers may choose to receive payment when they appear in a search, for instance in the form of royalties, or if their data is sold to a third party or a fourth party etc.—and they receive royalties each time their data or NFT is used.
4. To require payment for viewing their wallet\data.

As used herein, the term “certificate issuers” or “issuers” refers to institutions (for example but not limited to educational, medical, financial, patent, legal, or governmental institutions) or professional companies that provide/award certificates and authenticated NFT certificates. As used herein the term “certificate holders” or “holders” refers to entities who hold or are awarded/provided with certificates, and/or are named on these certificates and/or authenticated NFT certificates from certificate issuers. As used herein, the term “certificate” refers to any of a diploma, certification, document, agreement, contract, logo, bank-cheque, insurance police, medical test result, receipt, or similar item that is generated by a certificate issuer and made available to a certificate holder. As used herein the term “certificate viewers” or “viewers” refers to entities that view authenticated NFT certificates from certificate issuers that may be held by certificate holders. In some embodiments, viewers may search in the wallets of holders according to characteristics, types of certificates etc. In some embodiments viewers can search within the data associated with the NFTs or collected about the holders or issuers. In some embodiments, viewers may be required to pay, for instance in royalties to the holders or issuers that they viewed\searched amongst. As used herein “NFTC” may include digital certificates represented by NFTs or smart contracts or any other form of blockchain based record. As used herein, “wallet” refers to a digital tool or software application that allows holders/issuers to securely store, manage, and interact with digital assets (NFTCs) on a blockchain, the wallet storing cryptographic keys, for accessing and managing the digital assets on the blockchain. Thus, as used herein, a wallet may be said to “store” or “hold” an NFTC even though the NFTC is recorded on a blockchain and the related digital certificate may be stored elsewhere. A wallet may be part of an app as described below or may be a standalone wallet.

As used herein an NFT or smart contract is a unit of data recorded and/or stored on a blockchain that may certify a digital asset to be unique and therefore not interchangeable. NFTs may be used to represent digital items such as images, photos, videos, audio, and other types of digital files. As used herein an NFT represents a unique digital asset where an underlying smart contract infrastructure may enable the functionality and properties associated with an NFT. For NFTCs described herein, the blockchain may stores a unique identifier, metadata, and a reference or link to the location where the digital certificate is stored. This location may be an external hosting platform, a decentralized file storage system, or a centralized server such as the NMS described below. In some embodiments, the digital certificate may be stored on the blockchain.

Consistent with disclosed embodiments, a system for authenticating a digital certificate includes at least one processor configured to: convert a digital certificate into a non-fungible token certificate (NFTC); and to transfer the NFTC to a holder wallet of a holder named on the digital certificate. In some embodiments, the at least one processor is further configured to store the NFTC in an issuer wallet before transferring the NFTC to the holder wallet, wherein the issuer wallet is held by an issuer authorized by the system to convert the digital certificate.

In some embodiments, the at least one processor is further configured to authorize the issuer. In some embodiments, the holder wallet is one of a plurality of holder wallets, and wherein each of the plurality of holder wallets is configured to hold an NFTC of a digital certificate from a different field.

In some embodiments, the at least one processor is further configured to select a blockchain for recording the NFTC according to the field of the digital certificate associated with the NFTC. In some embodiments, the digital certificate is an academic diploma. In some embodiments, the NFTC includes one or more of the following metadata: name of teaching institution, unique identifier of the holder, major\department of graduation, or degree obtained.

In some embodiments, the at least one processor is further configured to provide the NFTC for viewing in the holder wallet. In some embodiments, the at least one processor is further configured to provide remuneration to the holder when the NFTC is viewed or searched for. In some embodiments, the at least one processor is further configured to provide a link to the NFTC in the holder wallet.

In some embodiments, the at least one processor is further configured to provide a marketplace for requesting, searching, issuing, and viewing of NFTCs. In some embodiments, the at least one processor is further configured to provide a metaverse in which users may interact the NFTC. In some embodiments, the at least one processor is further configured to submit a request for conversion of the digital certificate to the NFTC by the holder named on the digital certificate.

In some embodiments, the NFTC includes one or more of the following metadata: issuer name, holder name, digital certificate type, digital certificate image, certificate date of issue, certificate number, or certificate expiry date. In some embodiments, the at least one processor is further configured to provide the holder with control over one or more of: who to allow to view the holder wallet, whether to enable viewers to find the holder in a search; whether to receive payment for appearing in a search; or whether to require payment for a viewer viewing the holder wallet. In some embodiments, the field of the digital certificate is one of academic, patent, medical, financial, insurance, legal, trademark, or logo.

In some embodiments, the at least one processor is further configured to provide a user interface showing digital certificates along with an indication showing whether the digital certificates have been authenticated by conversion to NFTCs or not.

Consistent with disclosed embodiments, a non-transitory computer readable medium may contain instructions that when executed by at least one processor, cause the at least one processor to perform operations including: converting a digital certificate into a non-fungible token certificate (NFTC); and transferring the NFTC to a holder wallet of a holder named on the digital certificate. In some embodiments, the operations further include storing the NFTC in an issuer wallet before transferring the NFTC to the holder wallet, wherein the issuer wallet is held by an issuer authorized by the system to convert the digital certificate.

Consistent with disclosed embodiments, a method includes: converting a digital certificate into a non-fungible token certificate (NFTC); storing the NFTC in an issuer wallet; and transferring the NFTC to a holder wallet of a holder named on the digital certificate; wherein the issuer wallet is held by an issuer authorized to convert the digital certificate.

This Summary is provided to introduce a selection of concepts in a simplified form that may be further described in the Detailed Description below. It may be understood that this Summary is not intended to identify key features or essential features of the invention, nor is it intended to be used to limit the scope of the invention. The details of one or more embodiments of the invention may be set forth in the accompanying drawings and the description below. Other features will be apparent from the description and drawings, and from the claims.

### BRIEF DESCRIPTION OF THE DRAWINGS

The accompanying drawings, which may be incorporated in and constitute a part of this specification, illustrate several embodiments and, together with the description, serve to explain the disclosed principles. In the drawings:

FIGS. 1A-1D illustrate system for providing authenticated NFT certificates (NFTC) in accordance with embodiments of the invention;

FIG. 2A is a flow diagram of an example process for providing and handling NFTCs in accordance with embodiments of the invention;

FIGS. 2B-2E illustrate exemplary graphical user interfaces for the system in accordance with embodiments of the invention.

### DETAILED DESCRIPTION

Reference will now be made in detail to non-limiting embodiments of the invention which may be illustrated in the accompanying drawings. The embodiments may be described below by referring to the drawings, wherein like reference numerals refer to like elements. When similar reference numerals may be shown, corresponding description(s) may be not repeated, and the interested reader is referred to the previously discussed figure(s) for a description of the like element(s).

The invention, in embodiments thereof, may provide a technical solution to the challenging technical problem of authenticating certificates with the system having at least one processor (e.g., processor, processing circuit or other processing structure described herein), including methods, systems, devices, and computer-readable media. For ease of discussion, example methods may be described below with the understanding that aspects of the example methods apply equally to systems, devices, and computer-readable media. For example, some aspects of such methods may be implemented by a computing device or software running thereon. The computing device may include at least one processor (e.g., a CPU, GPU, DSP, FPGA, ASIC, or any circuitry for performing logical operations on input data) to perform the example methods. Other aspects of such methods may be implemented over a network (e.g., a wired network, a wireless network, or both).

As another example, some aspects of such methods may be implemented as operations or program codes in a non-transitory computer-readable medium. The operations or program codes may be executed by at least one processor. Non-transitory computer readable media, as described herein, may be implemented as any combination of hardware, firmware, software, or any medium capable of storing data that is readable by any computing device with a processor for performing methods or operations represented by the stored data. In a broadest sense, the example methods may be not limited to particular physical or electronic instrumentalities, but rather may be accomplished using many differing instrumentalities.

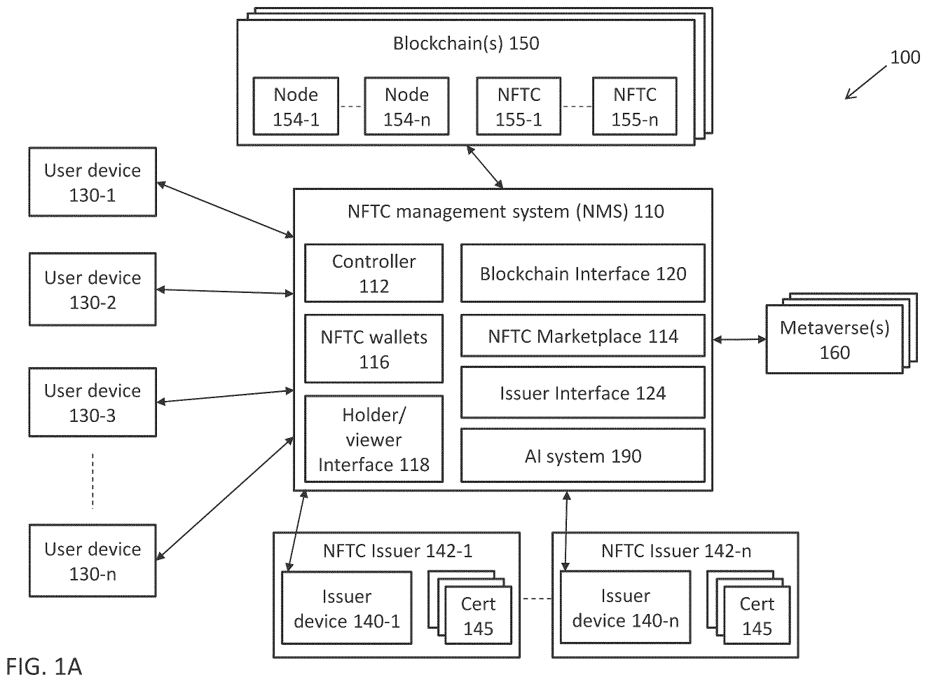

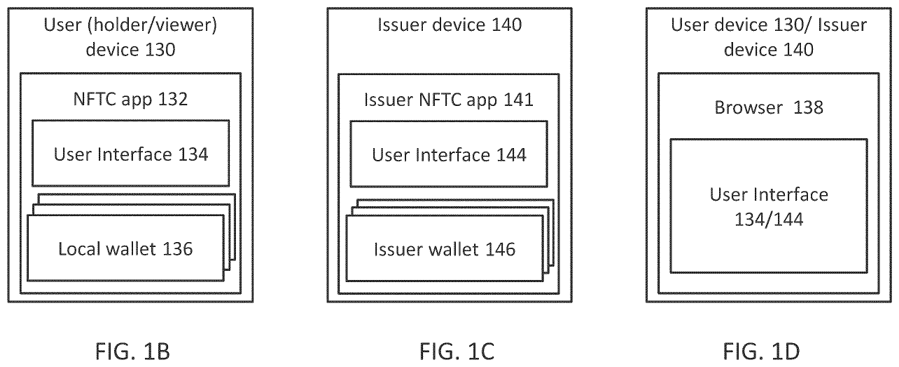

FIGS. 1A-1D illustrate system 100 for providing authenticated NFT certificates (NFTC) in accordance with embodiments of the invention. In system 100, certificate issuers, certificate holders and certificate viewers interact with an NFTC management system (NMS) 110 and also with one or more blockchains 150 where NFTCs 155 are recorded. A digital certificate 145 may be converted by NMS 110 into an NFTC 155 that may be used by a certificate holder to prove that a certificate 145 has been issued by a genuine certificate issuer.

Certificate holders and viewers use user devices 130-1 . . . 130-n. The components of system 100 are in data communication using wired or wireless network configurations and protocols that facilitate the intercommunication of the computing devices therein. Each of the components of system 100 as shown in FIG. 1A can be implemented in a localized or distributed fashion in a computer network.

NMS 110 and the modules and components that are included in NMS 110 may run on a single computing device (e.g., a server) or multiple computing devices (e.g., multiple servers) that are configured to perform the functions and/or operations necessary to provide the functionality described herein. NMS 110 and the modules and components that are included in NMS 110 may include or may be in communication with a non-transitory computer readable medium (such as memory containing instructions that when executed by at least one processor (such as controller 112) are configured to perform the functions and/or operations necessary to provide the functionality described herein. While system 100 is presented herein with specific components and modules, it should be understood by one skilled in the art, that the architectural configuration of system 100 as shown is simply one possible configuration and that other configurations with more or fewer components are possible. As referred to herein, the “components” of NMS 110 may include one or more of the modules or services shown in FIG. 1A as being included within NMS 110. NMS 110 may be operated by an NMS administrator, an entity that may receive remuneration for operation of NMS 110 for providing authenticated NFTCs.

NMS 110 may include a controller service 112. Controller service 112 may manage the operation of the components of NMS 110 and may direct the flow of data between the components of NMS 110 and also the data flow for interaction with external components 130, 140, and blockchain 150. Where NMS 110 is said herein to provide specific functionality or perform actions, it should be understood that the functionality or actions are performed by controller service 112 that may call on other components of NMS 110 and/or external components.

NMS 110 may include an NFTC marketplace service 114. NFTC marketplace service provides backend ecommerce type functionality including but not limited to requesting, issuing, and viewing of NFTCs 155. NFTC marketplace service 114 may include features including but not limited to NFTC inventory management, NFTC search, shopping carts, payment processing, currency conversion, privacy alternatives (enabling showing or hiding NFTCs on system, encryption of data and so forth.

NMS 110 may include online NFTC wallets 116. NFTC wallets 116 may reflect NFTCs 155 held by issuers or holders as an alternative to local wallets 136 or 146 (FIGS. 1B and 1C) running on user devices 130 or issuer devices 140.

NMS 110 may include user interface (UI) service 118. UI service 118 may generate code for generation of graphical user interfaces on user devices 130 and issuer devices 140. UI service 118 may base the generated UI code on data provided by NFTC wallets 116 and/or NFTC marketplace 114.

NMS 110 may include a blockchain interface 120 for creation and maintenance of NFTCs 155 on blockchain(s) 150.

NMS 110 may include an AI system 190 for data collection, analysis, and insight regarding NMS functionality, wallets of holders, issuers etc.

NMS 110 may include an issuer interface 124 for receiving certificate data from issuers 142 that operate issuer devices 140 and for querying certificate data from issuers 142. In some embodiments, issuer interface 124, may also authorize/verify access and communication with NMS 110 by an issuer 142 to prevent imposter issuers.

System 100 may include one or more blockchains 150. Blockchain(s) 150 may be any form of blockchain as known in the art and may provide distributed ledger functionality as known in the art. NFTCs 155 are recorded on blockchain 150 that is configured for recording of NFTCs 155 as used by system 100. Actions involving NFTCs 155 as described herein (such as issuing, transferring, adding data) should be understood as being manifested by updates to the token record or smart contracts on blockchain 150 or addition of records in new blocks on blockchain 150. Blockchain 150 may include nodes 154 that perform the computations required for generating and maintaining blockchain 150.

User devices 130 and issuer devices 140 can be of varying type, capabilities, operating systems, etc. Devices 130 and 140 may include a processor and a non-transitory computer readable medium (such as memory containing instructions that when executed by the at least one processor are configured to perform the functions and/or operations necessary to provide the functionality described herein. For example, user devices 130 and issuer devices 140 may include PCs, tablets, mobile phones, laptops, or any other device/mechanism that allows for interaction with NMS 110. Furthermore, NMS 110 can concurrently accept connections from and interact with multiple user devices 130 and issuer devices 140.

In some embodiments, such as shown in FIG. 1B, a holder/viewer using user device 130 may interact with NMS 110 via an NFTC app 132 installed on user device 130. NFTC app 132 includes a graphical user interface 134 for defining NFTC-related interactions with NMS 110 such as use of the NFTC marketplace 114 for requesting/viewing NFTCs 155.

NFTC app 132 may further include one or more local NFTC wallets 136 (or “holder wallet” 136) to reflect NFTCs 165 held by a holder. In some embodiments, multiple NFTC wallets 136 may operate on a user device 130 each handling different types of NFTCs from different issuers and/or NFTCs stored on different blockchains 150. In some embodiments, multiple NFTC apps 132 may operate on a user device 130 each handling different types of NFTCs from different issuers and/or NFTCs stored on different blockchains 150 and\or for different segments (for example, but not limited to: professional wallet, financial wallet, medical wallet, legal wallet etc.). For simplicity FIG. 1A illustrates a system with a single NMS 110 but this embodiment should not be considered limiting.

In some embodiments, such as shown in FIG. 1C, an NFTC issuer 142 using issuer device 140 may interact with NMS 110 via an issuer NFTC app 141 installed on issuer device 140. Issuer NFTC app 141 may include a graphical user interface 144 for defining NFTC-related interactions with NMS 110 such as defining NFTC parameters (described below) or responding to certificate authentication queries. Issuer NFTC app 141 may further include one or more issuer wallets 146 to reflect NFTCs 155 issued by an issuer. In some embodiments, multiple issuer wallets 146 may operate on an issuer device 140 each handling different types of NFTCs (for example, but not limited to different departments or subjects within issuer 142) and/or NFTCs stored on different blockchains 150. Apps 132 and 141 may have similar functionality, but NFTC issuers may require additional functionality for managing the certificates 145 and related NFTCs 155 that they issue, authenticate and/or store.

In some embodiments, such as shown in FIG. 1D, a user device 130 or issuer device 140 may interact with NMS 110 via GUI 134, 144 generated in a web browser 138 running on user device 130 or issuer device 140. For example, the holder/viewer can navigate in web browser 138 to a web address provided by an NMS 110 (such as for interface 118) that will generate the code representing interfaces 134, 144 within browser 138.

In some embodiments, the system may include one or more metaverses 160 providing virtual-reality spaces in which users may interact (using, for example user devices) with a computer-generated environment and interact with other users that are using metaverse and interact with the NFTCs as described herein. In some embodiments, within a metaverse, viewers or holders may view, search, and manage NFTCs, either in metaverse versions of app 132 or in dedicated spaces for NFTC interaction.

In some embodiments, in a metaverse classroom, a token/authentication NFTC may be used to enter the classroom, proving that the student is enlisted, as an extra layer of security, and the participation of a student in classes is rewarded with further authenticated NFTCs. In some embodiments, the NFTCs the students collect can be used to trade, exchange, vote as a DAO etc. on the marketplace and metaverse, and anywhere within the college ecosystem (physical or digital campus). In some embodiments, when students enter the campus or class, whether physical or digital, their authentication NFTC on their mobile is used to verify that it is them, and they can enter. In some embodiments, this authentication NFTC can be used to prove that a student was in class as well. In some embodiments, the student can thus be rewarded for attendance.

In some embodiments, airdrops may be sent to wallets that hold the authenticated student NFTC, and these airdrops can be later used/traded/sold on the physical and digital metaverse, or in the NFTC marketplace described herein. In some embodiments, these authenticated NFTCs can be used as entrance enablers to campus clubs, societies, sports teams, and campus residences. In some embodiments, an implementation would be that someone who is on an official school team from high school to college, receives an Authenticated NFTC into their wallet, as explained herein. In some embodiments, this NFTC also confirms their position on the team. In some embodiments, for every game played, the players receive an NFTC of the official Cap, together with points scored and game data.

The number of components shown in FIG. 1A is illustrative and should not be considered limiting. For example, each of blockchains 150 may include multiple nodes 154-1 . . . 154-n, and multiple NFTCs 155-1 . . . 155-n; multiple user devices 130-1 . . . 130-n may use system 100; and system 100 may include multiple issuers 142-1 . . . 142-n, each operating one or more issuer devices 140-1 . . . 140-n and managing multiple certificates 145.

In some embodiments system 100 may be a SaaS system, that enables issuers 142 to upload certificates 145 they want to distribute. In other embodiments, an issuer 142 may upload certificates 145 to an online folder/directory/drive such that a 3^{rd} party may perform the process of conversion of NFTCs 155 on behalf of the issuer. In some embodiments, the 3^{rd} party may be the owner/operator of NMS 110.

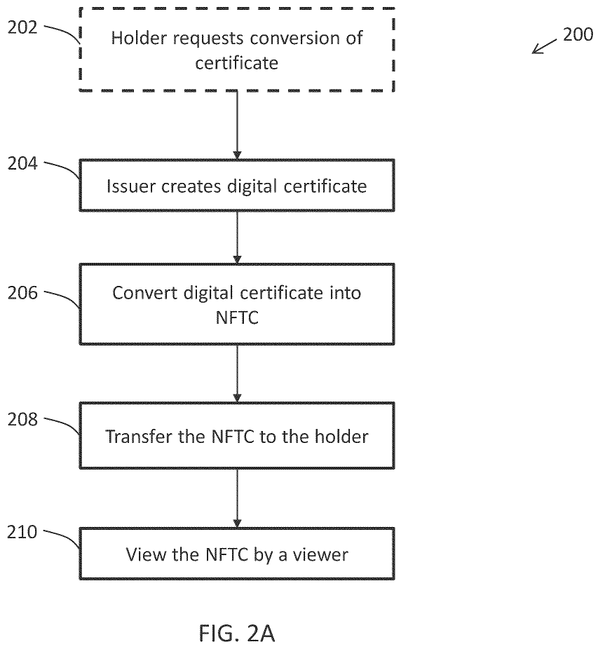

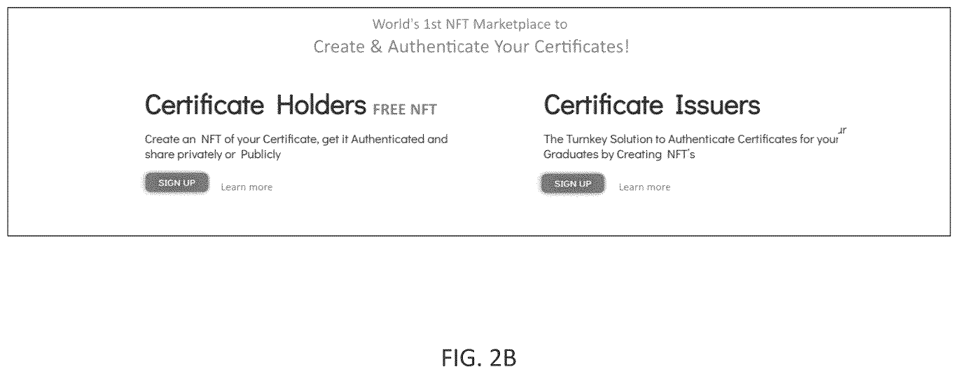

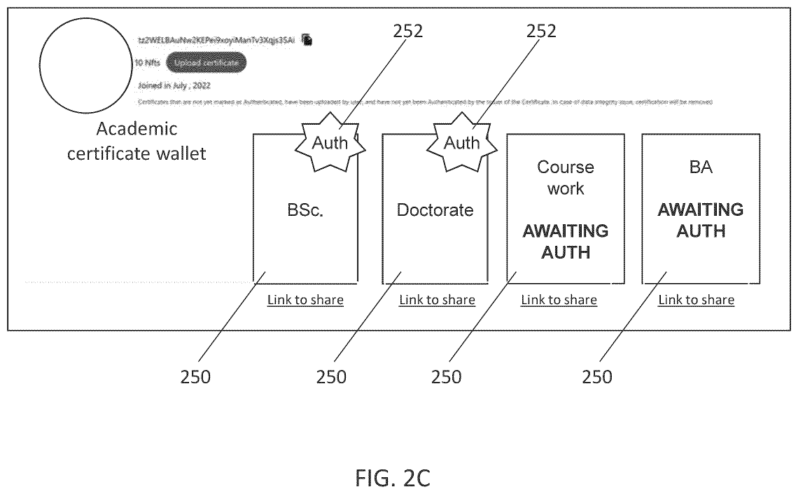

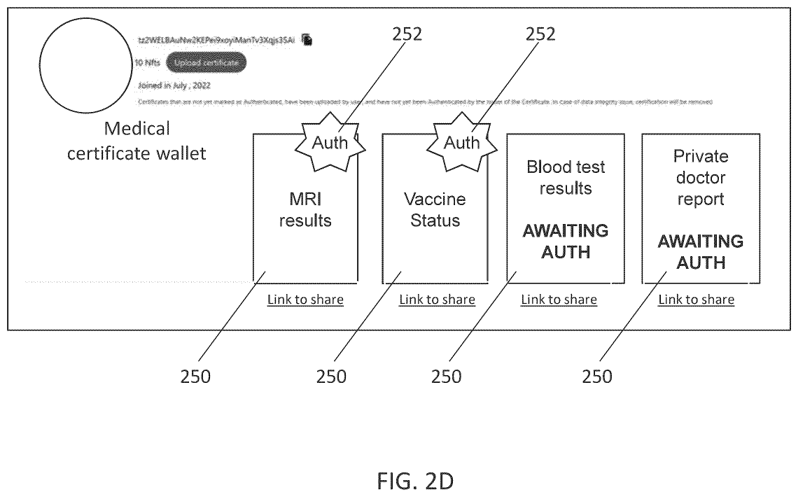

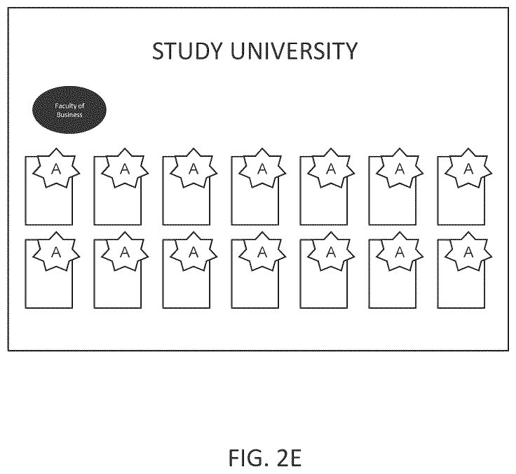

FIG. 2A is a flow diagram of an example process 200 for providing and handling NFTCs in accordance with embodiments of the invention. FIGS. 2B-2E illustrate exemplary graphical user interfaces for system 100 in accordance with embodiments of the invention. This process 200 may for example be performed by system 100 as described above. The steps below are described with reference to a non-transitory computer readable medium containing instructions that when executed by one processor performs one or more of operations described at each step. The processor and non-transitory computer readable medium may correspond to NMS 110 and/or any of the other components as described with reference to FIGS. 1A-1D.

In use, system 100 may be used by certificate issuers 142 to create authenticated NFTCs that prove that a digital certificate 145 (or simply “certificate 145” herein) represented by the issued NFTC 155 and related to a holder has been issued by an official issuer 142. In some embodiments, system 100 may verify/authenticate an issuer 142 to ensure that issuer 142 is authorized to issue and manage certificates 145. In step 204 an issuer 142 may create a digital certificate 145 such as by scanning a paper certificate to create a digital certificate 145 (an image or other file type). Alternatively, in some embodiments, a digital certificate 145 may be generated (not by scanning) representing such a paper certificate. In some embodiments, the issuer app 141 may be configured to create digital certificate 145, such as by scanning a paper certificate.

In optional step 202, process 200 may begin with a holder of a certificate 145 requesting authentication by conversion of the held certificate 145 into an authenticated NFTC. Such a step may occur, for instance, where a certificate was issued prior to the availability of the system disclosed herein. FIG. 2B shows an exemplary screenshot, such as provided via a browser 138, for use of system 100 by certificate holders and issuers. In some embodiments, a holder may use an NFTC app to convert certificate 145 into a digital certificate and then an unauthenticated NFTC (known to be unauthenticated since it originates from a holder wallet and not an issuer wallet) and then transfer the unauthenticated NFTC to the wallet of a relevant issuer. Such an unauthenticated NFTC may then be reviewed by the relevant issuer and converted into an authenticated NFTC in step 204.

In step 206, the issuer may, for example, use an issuer app 141 to convert the digital certificate (or unauthenticated NFTC) into an authenticated NFTC. The NFTC issuing process may include creating and associating an NFT 155 on blockchain 150 with a unique ID for the certificate 145 as well as the secure keys associated with the issuer wallet 146. In some embodiments, certificates from different fields (academic, medical, financial) may be converted to NFTCs on different blockchains. In some embodiments, the NFTC 155 includes data related to certificate 145 such as but not limited to: issuer name (including but not limited to issuer names, contact details, address, and so forth), holder name (including but not limited to first and last names, contact details, ID number, and so forth), certificate type (diploma certification, etc.), digital certificate image, certificate date of issue, certificate number/ID, certificate expiry date, supplementary data (such as but not limited to grades, scores, and so forth), and so forth. FIG. 2B shows an exemplary screenshot, such as provided via a browser 138, for use of system 100 by an issuer to convert a certificate into an NFTC. In some embodiments, the content of the certificated may be encrypted so as to ensure privacy of the holder.

In step 208, the issuer may transfer the issued NFTC 155 to a wallet 116 or 136 of a holder. A holder may then use a holder NFTC app 132 to review and share the NFTC. FIGS. 2C and 2D show exemplary user interfaces for viewing wallets of NFTCs, where each wallet is related to a different field (academic, medical) and the illustrated NFTCs 250 are shown as authenticated via a label 252. It should be appreciated that the app is configured for viewing or sharing the NFTC without requiring that the holder have any knowledge or understanding of NFTs or blockchain. In some embodiments, the holder simply sees a certificate image optionally with related certificate data and an indication of the authenticity of the certificate (since it issued from the wallet of the issuer associated with the certificate).

In step 210, a viewer may search for, pay for viewing and/or view the NFTC 155 held by a holder such as by using app 132. It should be appreciated that the app is configured for viewing the NFTC without requiring that the viewer have any knowledge or understanding of NFTs or blockchain. In some embodiments, the viewer simply sees a certificate image optionally with related certificate data and an indication of the authenticity of the certificate. In some embodiments, such as shown in the exemplary screenshot of FIG. 2E, a viewer (or holder) may view multiple NFTCs from an issuer such as by accessing NFTC marketplace 114 via app 132.

In a non-limiting example from the field of academic studies: A university (issuer 142) may issue official diplomas with a graphic representation, which can be converted into NFTCs. Each graduate (holder) may be issued with a certificate of graduation (NFTC), including at least the graduate's name.

This NFTC may be added to the graduate's digital wallet (such as wallet 136), which may be created for each graduate by the issuer app. In some embodiments, a holder may have multiple wallets 136, each related to a specific subject or field. In a non-limiting example, the NFTC representing the graduate's certificate may be stored in an “academic” wallet as opposed to a professional qualification NFTC stored in a “profession” wallet. In some embodiments, these wallets may also be merged, and create a “qualifications wallet”. By holding the NFTC in a graduate's digital wallet, a graduate may prove that his/her diploma is authentic and had been issued by the academic institution since the NFTC originated from an official digital wallet that belongs to the official certificate issuer. This NFTC can be showcased (shared) by graduates, such as on their CV, social media, LinkedIn, etc. In some embodiments, the NFTC of the graduate may further include grades received as part of the studies of the graduate. In some embodiments, the NFTC of the graduate may further include any one or more of honors, awards, or publications that were received/created during the studies of the graduate, and/or a list of courses the Graduate studied, and/or a list of characteristics of the graduate.

Any entity (viewer) that wants to authenticate the diploma held by a graduate, may see (in the description and/or data of the NFTC) that the NFTC of the diploma was issued and/or sent to the graduate's wallet (holder), from the official digital wallet of the academic institute (issuer) that issued the diploma. It should be appreciated that an NFTC that does not originate from the official digital wallet of the issuer (academic institution) may be considered suspect or fake. This process applies to all other examples herein.

In some embodiments, the graduate may decide who and how their profiles (wallets with NFTCs) can be viewed, and at what fee for the viewer. For instance, Graduates can decide: Who to allow to view their various wallets (via a link for example); to enable viewers to find them when viewers search according to characteristics and certificates; to receive payment when they appear in a search; and to require payment for viewing their wallet\data.

In a non-limiting example from the field of patents and patent applications: A patent office (issuer) may issue official documentation about patent applications pending in a document, which can be “minted” as an NFTC, that could also hold additional data, with or without encryption, kept on a blockchain. Each patent application submitted receives an application number, that appears on a document (such as a filing receipt), and/or in the data, and this document (which holds the details of the number of submission and other details) is minted into an NFTC, which may be held in the patent office's official wallet, along with the additional data. This NFTC, along with the data, may be sent to a designated digital wallet (such as a “patents” wallet), created for the entity (holder) submitting the patent application. By holding the NFTC with or without the additional data, in a holder digital wallet, the entity that had submitted a patent may prove that he has a true patent pending that has been issued by the patent office. In some embodiments, this NFTC may be showcased by a patent submitter, wherever needed. Further, granted patents and trademarks certificates may be issued as NFTCs, and patent assignments may be stored as NFTCs according to the methods disclosed herein.

Any entity (viewer) that wants to authenticate the patent application, may see that the NFTC of the application in the submitter's (holders) wallet, was received from the official patent office (issuer) that issued the documentation of the submission. It should be appreciated that an NFTC that was not received from the official digital wallet of the patent office may be considered suspect or fake. Alternatively, an NFTC (step 202) that did not come from the issuer wallet may have been minted by a holder and may be waiting for official authentication by an issuer.

In a non-limiting example from the field of medical information, including vaccination status, MRI Results, CT results etc.: A medical institution (issuer) may issue official documentation about a patient's medical record, (such as vaccination status, MRI results etc.). This documentation may have a graphic representation, with additional relevant details and characteristics, which may be minted as an NFTC. For each patient that receives the medical documentation, (such as a vaccine status, or MRI result), an NFTC may be minted with the medical status\documentation, and additional data. This NFTC may be sent to a designated digital wallet (in some embodiments a medical wallet), created for each patient (holder). By holding the NFTC in a digital wallet, the patient may prove that he holds an authentic medical record that has been issued by the medical institution. This NFTC may be shown by each patient, wherever needed.

Any entity (viewer) that wants to authenticate the patient's (holders) medical documentation and data, may see that the NFTC of the patient originated from the official medical institution (issuer) that issued the medical documentation. It should be appreciated that an NFTC that did not originate from the official digital wallet of the medical institution may be considered suspect or fake. Alternatively, an NFTC (step 202) that did not originate from the issuer wallet may have been minted by a holder and may be waiting for official authentication by an issuer, and may be marked as such.

In a non-limiting example from the field of finance and specifically KYC, and\or bank cheques or financial reports: A financial institute (issuer) may issue an official certification that an entity has passed full KYC. This certification may have a digital representation of a document that has customer KYC details. This document may be minted as an NFTC, with the details of the person that completed the KYC. This NFTC may be sent to a designated digital wallet (in some embodiments, the holder's financial wallet), created for each customer that completed a KYC. By holding the NFTC in a person's digital wallet, the customer (holder) may prove that he has completed a KYC that was already approved by an existing financial institute, and that the KYC is authentic. This NFTC may be showcased by the customer at other financial institutions, so that a KYC process is not required again.

Any entity (viewer) that wants to authenticate the KYC, may see that the NFTC of the KYC that was sent to the customer's (holder's) wallet, originated from the official digital wallet of an official financial institute (issuer). It should be appreciated that an NFTC that did not originate from the official digital wallet of the financial institution may be considered suspect or fake. Alternatively, an NFTC (step 202) that did not originate from the issuer wallet may have been minted by a holder and may be waiting for official authentication by an issuer.

In a non-limiting example from the field of finance and specifically financial information, bank cheques and\or financial statements: A financial institute (issuer) may issue an official certification that an entity has generated a bank cheque or holds certain financial information. This certification may have a digital representation of a document that has the cheques details or the financial statements details. This document may be minted as an NFTC, with the details of the cheque or the financial statement. This NFTC may be sent to a designated digital wallet (in this case a financial wallet), created for each customer that created a cheque or had a financial statement sent. By holding the NFTC in a person's digital wallet, the customer (holder) can prove that he has created a bank cheque that has been already approved by an existing financial institute, and that the bank cheque is authentic, or prove that the financial statement or financial information is authentic. This NFTC can be showcased by the customer at other financial institutions, or to any entity.

Any entity (viewer) that wants to authenticate the bank cheque, financial data or financial statement, can see the NFTC was sent to the customer's (holder's) wallet, straight from the official digital wallet of an official financial institute (issuer). It should be appreciated that an NFTC that was not sent from the official digital wallet of the financial institution may be considered suspect or fake. Alternatively, an NFTC (step 202) that did not come from the issuer wallet may have been minted by a holder and may be waiting for official authentication by an issuer.

In a non-limiting example from the field of Insurance and specifically Insurance policy or appraisers report: An Insurance institute or appraiser (issuer) may issue an official certification that an entity has for instance an Insurance Policy, or appraisal. This certification may have a digital representation of a document that has the Insurance Policy details appraisal report, pictures of insures products etc., and additional data. This document may be minted as an NFTC, with the relevant details. This NFTC may be sent to a designated digital wallet (in this case the insurance or financial wallet), created for each customer. By holding the NFTC in a person's digital wallet, the customer (holder) can prove that he has an Insurance Policy, or appraisal that has been already approved by an existing Insurance institute, and that the Insurance Policy or appraisal is authentic. This NFTC can be showcased by the customer at other Insurance institutions, Police, or to any entity.

Any entity (viewer) that wants to authenticate the insurance policy, can see the NFTC of the insurance or appraisal was sent to the customer's (holder's) wallet, straight from the official digital wallet of an official Insurance or appraisal institute (issuer). It should be appreciated that an NFTC that was not sent from the official digital wallet of the Insurance institution may be considered suspect or fake. Alternatively, an NFTC (step 202) that did not come from the issuer wallet may have been minted by a holder and may be waiting for official authentication by an issuer.

In a non-limiting example from the field of law, including legal documents, court rulings etc.: A legal body (issuer) may issue official legal documentation, (such as wills, pre-nuptial agreements, legal agreements, court orders, rulings, legislation etc.). This documentation may have a graphic representation, with additional relevant details and characteristics, which may be minted as an NFTC. For each applicable side in a legal proceeding that receives the legal documentation (side), an NFTC may be minted with the additional data. This NFTC may be sent to a designated digital wallet (in some embodiments a legal wallet), created for each applicable side in a legal proceeding that receives the legal documentation (holder). By holding the NFTC in a digital wallet, the side may prove that he holds an authentic legal document record that has been issued by the legal body. This NFTC may be shown by each side, wherever needed.

Any entity (viewer) that wants to authenticate the sides (holders) legal documentation and data, may see that the NFTC of the side originated from the official legal body (issuer) that issued the legal documentation. It should be appreciated that an NFTC that did not originate from the official wallet of a legal body may be considered suspect or fake. Alternatively, an NFTC (step 202) that did not originate from the issuer wallet (for instance a will) may have been minted by a holder and may be waiting for official authentication by an issuer, and could be marked as such. The viewer in this case, may also be an AI system, that uses legal information as a source. In this case the need to authenticate the legal information (especially official court rulings) becomes even more necessary when artificial intelligence (AI) tools use this data, and may rely on unauthenticated rulings, data and certifications.

In a non-limiting example from the field of marketing and brand logos/trademarks. A company (issuer) may issue a logo on their website and mint the logo as an NFTC linked to the official company wallet. A brand logo that appears on the internet in any form, will only be genuine if issued from the company wallet.

In a non-limiting example from the field of blogger and review text and image content: The text may be minted as an NFTC to authenticate that it belongs to the content creator (issuer), and that that creator has been verified as a real person as part of registration in system 100. Content that is issued as an NFTC may be considered as authentically created by the content creator. Such a solution may address the problem of stolen content in that the content creator can prove that the content belongs to them, and that a verified person wrote the content.

Furthermore, all the content from all the unlimiting examples above may be monetized by the genuine creator on the NFTC marketplace, therefore providing a solution to all types of agencies including advertising agencies and platforms that offer to help monetize content from creators and\or owners on the internet and in metaverses.

It should be appreciated that similar examples can be provided for each of the various fields listed in the Summary above, and for additional cases where authentication of certificates is needed.

In more detail, optional step 202 may proceed as follows: a user may upload and mint an existing certificate and holds it in a personal designated digital wallet of the holder app. At this time the NFTC is not yet authenticated; The holder may choose to request to authenticate the document that has been minted as an NFTC; In order to authenticate the NFTC, the user may send the NFTC to a designated “incoming” digital wallet of the entity (issuer) that is deemed as the official issuer of the certificate; The issuer may see in an “incoming” digital wallet, NFTCs that have been sent to be verified. When the issuer sees that the received NFTC is authentic, the issuer may send the NFTC back from an official wallet to the holder wallet, thus authenticating that the NFTC is verified, as described above.

In some embodiments, a designated official outbound issuers wallet may be provided, in parallel to an incoming wallet, for security reasons. This means that for each NFTC sent by a holder to an issuer, a separate digital wallet may be created. In addition to these multiple wallets, the issuer may hold one “official wallet” that is the wallet from which the official NFTCs that are authentic originate.

Non-limiting examples of certificate holders wanting to authenticate their certificates using the system disclosed herein may include:

A graduate (holder) holds an academic diploma he received 10 years ago. He would like to prove its authenticity. The graduate may access the platform (such as via app 132 or browser 138) and may receive a designated holder local wallet. The graduate may now upload a picture of his diploma and mint it as an unauthenticated NFTC. This unauthenticated NFTC will appear in his wallet (for example in his “academic wallet”), and, in some embodiments, on a webpage provided via system 100. In order to authenticate the NFTC, the graduate may send the unauthenticated NFTC to the wallet of the original issuer of his diploma, or a professional authenticating body. The issuer of the diploma, or professional authentication body may now see that this graduate is requesting authentication. If the issuer of the diploma, or the professional authenticating body agrees that this diploma is authentic, then the issuer may send an authenticated NFTC to the graduate's wallet. This NFTC could be the same NFTC minted by the graduate or could be an NFTC of the image of the official diploma the academic institute issues. When the graduate receives the NFTC from the issuer, then it is apparent that the NFTC came from the official wallet of the academic institution, therefore indicating that the diploma associated with the authenticated NFTC is authentic.

Now the wallet of the graduate holds an authenticated NFTC of his diploma that had been authenticated. Anyone the graduate chooses to show this NFTC to, may see that it originated from the official academic institution's wallet, and that therefore the NFTC is authentic. In some embodiments, this NFTC can be showcased on the graduates CV, LinkedIn etc. In some embodiments, the graduate may choose with whom to share the ability to view his page on the system, therefore showcasing all the diplomas he has, and for each NFTC it is clear which wallet it came from, and therefore whether the diploma is authentic.

It should be appreciated that similar examples can be provided for each of the various fields listed in the Summary above, and for additional cases where authentication of existing certificates is needed.

In some embodiments, this type of authentication may require payment from the holder for authenticating his documents. In some embodiments, this type of authentication may require payment from a viewer for authenticating documents uploaded by viewer who wants to authenticate documents and data.

In some embodiments, system 100 and NMS 110 may provide the exemplary functionality, rules, and characteristics as described below.

If specific certificates do not have a resale value (for instance in the case of legal, medical records, or academic degrees), the NFTC marketplace may not include a shopping cart, and the NFTC representations may not be available for sale. In some embodiments, royalties for using the data may still apply.

In some embodiments, the certificates, both in the wallets of the issuers, and in the wallets of the holders, may be blocked for outside viewing, and the data saved on the blockchain may be encrypted to enable privacy.

In some embodiments, holders' profiles (wallets) may hold various certificates and authenticated documentation from various fields and issuers. This data regarding the existence of authenticated certificates and documents may have resale value. In some embodiments, the holder may choose at some point whether they want to sell the data collected regarding the various certificates and documents held in their wallets thereby monetizing the authenticated data they own.

In some embodiments, users (holders) and\or issuers may decide who and how their profiles (wallets) can be used, and at what fee or royalties for the viewer. For example, Holders or issuers may decide:
1. Who to allow to view their various wallets (via a link for example).
2. To enable viewers to find them when viewers search according to characteristics and certificates.
3. In some embodiments, holders or issuers may choose to receive payment when they appear in a search, for instance in the form of royalties, or if their data is sold to a third party or a fourth party etc.—and they receive royalties each time their data or NFTC is used.
4. To require payment for viewing their wallet\data.

In some embodiments, NFTCs may only be minted by: certificate issuers (for instance: colleges, patent offices, courts, government officials, medical institutes, financial institutes etc.) and sent (airdropped) to a designated “certificate holder” wallet; certificate holders (for instance: graduates, customers of financial institute filling KYC, patients receiving medical treatment or vaccination): may upload scans of their physical certificates and mint them by themselves on the platform—and while they will be unverified—they can apply for authentication by sending to certificate issuer after minting.

In some embodiments, in case a certificate is uploaded and minted as NFTC by a holder, it is not yet authenticated. In some embodiments, for the document\certificate connected to the NFTC to be authenticated, the certificate NFTC may be sent from the uploader's digital wallet to a digital wallet of the original issuer, and only after the issuer authenticates that it is authentic—the issuer sends the NFTC of the certificate back to the holder's digital wallet, and then the NFTC may appear as authenticated, on the holder's profile page (which may be a digital wallet).

In some embodiments, a search function may exist for searching by names or attributes or data or characteristics of certificate holders & issuers (and should be updated whenever new certificate issuers or holders mint and update their names in profile). In some embodiments, searching by characteristics may cost a commission for viewers wanting to search amongst the authenticated certificates and documents. In some embodiments, this commission may be transferred partially to holder or issuer wallets that have been searched, enabling a form of monetization of the data and authenticated certificates they hold.

In some embodiments, when pressing the “Latest NFTs” segment on a webpage of an issuer, the page may showcase the projects that have been minted on the system by the issuer. When pressing on the latest NFT project, a user may be directed to the certificate issuer (college) public page. In some embodiments, the certificate holder page may be generated in the following ways: By a graduate pressing the “sign in” button on the homepage; or when a graduate (holder) receives a first NFT certificate that was generated from an issuer.

In some embodiments, the issuer may cancel an existing NFTC, because a certain pre-defined time has passed, pre-requisition no longer exists, or because the holder is not eligible to hold the certificate any more, or the certificate\document has become void. In this case the NFTC may be transferred back from the holder's wallet to the issuer, or another NFT will be created showing that the older certificate is void. In some embodiments, the link of the originating wallet would show that the NFTC is no longer valid.

In some embodiments, following successful sign-up\first entrance, a certificate holder page (which may be a digital wallet) may include one or more of these additional fields which can later be edited and searched for: full name, email address, phone number, bio/CV (free type field), location, link to social media (LinkedIn, Facebook, Instagram, twitter, etc.), date of birth, county of residence and so forth.

In some embodiments, the UIs may include a message similar to “Certificates that are not yet marked as Authenticated, have been uploaded by user, and have not yet been Authenticated by the Issuer of the Certificate. In case of a data integrity issue, certification will be removed”.

In some embodiments, certificate holders may upload additional certificates to their page, or digital wallet that holds certificates, as NFTCs. These NFTCs may appear as unauthenticated, until they are authenticated by an issuer.

In some embodiments, when uploading certificates as NFTCs, one or more of the following details are captured per certificate: country of issue, issuers name (college name in case of an academic certificate, legal entity name in case of a legal document, bank name in case of a financial document etc.), degree or course name (in case of academic data), description of certificate, a certificate image, date of expiry etc. In some embodiments, holders that upload a certificate may be warned with text similar to the following “by uploading your certificate, you are showcasing to the world that it is yours. Therefore, when the certificate is evaluated for authenticity, in case it is non-authentic, this will be easily visible to anyone viewing your page.”

In some embodiments, a fee may be charged for uploading and\or authenticating a certificate. In some embodiments, the disclosed system may also work with 3^{rd} parties that work with issuers to check that a certificate is authentic. When the approval is received, the certificate may appear as authenticated in the holder's wallet, i.e.: an official certificate may be minted as an NFTC and provided to the graduate's wallet.

In some embodiments, when an issuer uses the issuer app to convert a certificate into an NFTC, one or more of the following details may be collected for addition to the NFTC: (example is for a university): name of university, website of university, ID of student (or identification that was used at university), major\department of graduation (business, medicine, accounting etc.), degree obtained (BA, MA etc.). In an additional non-limiting example for financial data, detail may include: name of bank, website of bank, address of bank, ID of bank customer (or identification that was used at financial institute), type of financial statement, etc.

In some embodiments, NFTCs that are not yet verified by an issuer will include an indication that they are not yet authenticated. Alternatively, in some embodiments, authenticated or unauthenticated NFTCs may be placed in a separate tab or position on the website or app. In some embodiments, after authentication, a verification symbol may appear as an image or watermark as a layer on the NFTC, or a “authenticated” label 252 may be added (such as shown in FIGS. 2C and 2D), or the NFTC may move to an “authenticated” tab. In some embodiments, if certificates are issued by the academic institution the NFTC certificates may be authenticated by default.

In some embodiments, a holder (for instance a graduate) may have the ability to decide if they want their profile (digital wallets) to be visible to everyone, or just to those receiving links.

In some embodiments, issuers, holders, or viewers may need to pass a due diligence/approval process, optionally verified by a human administrator of system 100. In some embodiments, an issuer page (which may be an issuer digital wallet) may provide one or more of the following fields: official name of establishment, country, contact first name and last name and official work title, contact email and phone details, description and notes, links to social media, image/logo, and so forth.

In some embodiments, each issuer may have an issuer page (which may be a digital wallet) on the website provided by NMS 110. In some embodiments, an issuer page may feature multiple digital wallets for the various types of documents the issuer issued. In some embodiments, each wallet may feature: all the NFTs that have been issued, a link to mint verified NFTCs, a link to view and verify graduate submitted certificates, a link to report fake certificates. In some embodiments, pending approval NFTs that the holders have uploaded, will appear on a designated tab for authentication. In some embodiments, an issuer may authenticate uploaded NFTCs by selecting and pressing an “Authentication” button, that will add an indication that the NFTC is authenticated and may place the authenticated NFTC into the issuer official wallet. In some embodiments, an authentication indication may include an image or watermark on the NFTC image as a layer.

In some embodiments, the issuer page (which may in some cases be a digital wallet) may include minting capabilities that include one or more of the following that should be collected when minting: picture upload (in batch) of certificates, description of NFTCs, title, year, name of issuer, department\major (business\medicine etc.), name of collection, and so forth.

In some embodiments, an issuer app may provide the following capabilities: ability to create wallet for new holder (graduates\KYC fillers\vaccinated\patent applicant/inventor etc.), ability to add to wallet of existing holders (graduates (according to email address), ability to airdrop certificates to all wallets of holders (graduates, bank customers, appraisers, insurance companies).

In some embodiments, minting of an NFTC may also generate the creation of a “Certificate Holder Page” for each holder (which may be multiple digital wallets, each wallet designated to a different field). In some embodiments, The NFTCs may appear on each holder's page (which may be a digital wallet).

In some embodiments, descriptions of NFTCs may be determined by an issuer and each holder NFTC page will inherit those titles and descriptions. In some embodiments, the NFTC description may be set by the issuer such that holders cannot add one of their own to prevent holders from wrongly describing an NFTC.

In some embodiments, an AI could be added to the NMS (such as AI system 190), which may in some cases collect data from wallets, and NFTCs and associated data. The data collected may offer insight to holders, issuers and\or viewers. Examples may include, but are not limited to:
1. In the case of professional\academic wallets, the AI may share insight about what career paths could lead to various positions based on existing data in the NMS. The AI may advise holders, for instance, what their next career move should be, in order to reach a professional goal the holder indicates they are interested in.
2. Similarly, the AI could collect data from the NMS, and offer advise based on this data, to assist issuers in reaching predefined insights or goals. For instance—Universities could receive insights about types of possible students that could advance the university to reach a higher status. The ai could advise universities about potential candidates that are holders on the NMS.
3. Similarly, the AI could collect data from the NMS, and offer insights and advice to viewers searching for specific attributes. For instance, in the case of Head Hunters, the AI could advise which candidates or characteristics would be most beneficial based on the data collected from the NMS.
4. The AI system could offer personalized adds and commercials shown to specific holders or issuers according to the data collected about them. The payment for these adds could be distributed amongst the holders and issuers, so that they can monetize their data

These use cases may require additional charges by issuers and\or viewers. These charges may be distributed amongst the holders and issuers, so that they can monetize their data.

Unless otherwise defined, all technical and scientific terms used herein have the same meaning as commonly understood by one of ordinary skill in the art. The materials, methods, and examples provided herein are illustrative only and not intended to be limiting.

Implementation of the invention may involve performing or completing certain selected tasks or steps manually, automatically, or a combination thereof. Moreover, according to actual instrumentation and equipment of the invention, several selected steps may be implemented by hardware (HW) or by software (SW) on any operating system of any firmware, or by a combination thereof. For example, as hardware, selected steps of the invention could be implemented as a chip or a circuit. As software or algorithm, selected steps of the invention could be implemented as a plurality of software instructions being executed by a computer using any suitable operating system. In any case, selected steps of the invention could be described as being performed by a data processor, such as a computing device for executing a plurality of instructions.

Although the invention is described with regard to a “computing device”, a “computer”, or “mobile device”, it should be noted that optionally any device featuring a data processor and the ability to execute one or more instructions may be described as a computing device, including but not limited to any type of personal computer (PC), a server, a distributed server, a virtual server, a cloud computing platform, a cellular telephone, an IP telephone, a smartphone, a smart watch or a PDA (personal digital assistant). Any two or more of such devices in communication with each other may form a “network” or a “computer network”.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

In some embodiments, the system disclosed herein may be implemented on one or more servers or storage systems and/or services associated with a business or corporate entity, including for example, a file hosting service, cloud storage service, a hardware server, a virtual server, an online file storage provider, a peer-to-peer file storage or hosting service and/or a cyber locker. In some embodiments, the system disclosed herein may be provided in various deployments models including but not limited to cloud based, hardware server, or virtual.

Memory may include one or more types of computer-readable storage media including, for example, transactional memory and/or long-term storage memory facilities and may function as file storage, document storage, program storage, and/or as a working memory. The latter may, for example, be in the form of a static random-access memory (SRAM), dynamic random-access memory (DRAM), read-only memory (ROM), cache or flash memory. As long-term memory, memory may, for example, include a volatile or non-volatile computer storage medium, a hard disk drive, a solid-state drive, a magnetic storage medium, a flash memory and/or other storage facility. A hardware memory facility may, for example, store a fixed information set (e.g., software code) including, but not limited to, a file, program, application, source code, object code and the like.

As used herein the terms “machine learning” or “artificial intelligence” refer to use of algorithms on a computing device that parse data, learn from the data, and then make a determination or generate data, where the determination or generated data is not deterministically replicable (such as with deterministically oriented software as known in the art).

In some embodiments, machine learning algorithms (also referred to herein as machine learning models or artificial intelligence) may be trained using training examples, for example in the processes described herein. Some non-limiting examples of such machine learning algorithms may include classification algorithms, data regressions algorithms, image segmentation algorithms, mathematical embedding algorithms, support vector machines, random forests, nearest neighbors algorithms, deep learning algorithms, artificial neural network algorithms, convolutional neural network algorithms, recursive neural network algorithms, linear machine learning models, non-linear machine learning models, ensemble algorithms, and so forth. For example, a trained machine learning algorithm may comprise an inference model, such as a predictive model, a classification model, a regression model, a clustering model, a segmentation model, an artificial neural network (such as a deep neural network, a convolutional neural network, a recursive neural network, etc.), a random forest, a support vector machine, and so forth. In some examples, the training examples may include example inputs together with the desired outputs corresponding to the example inputs. Further, in some examples, training machine learning algorithms using the training examples may generate a trained machine learning algorithm, and the trained machine learning algorithm may be used to estimate outputs for inputs not included in the training examples. In some examples, engineers, scientists, processes and machines that train machine learning algorithms may further use validation examples and/or test examples. For example, validation examples and/or test examples may include example inputs together with the desired outputs corresponding to the example inputs, a trained machine learning algorithm and/or an intermediately trained machine learning algorithm may be used to estimate outputs for the example inputs of the validation examples and/or test examples, the estimated outputs may be compared to the corresponding desired outputs, and the trained machine learning algorithm and/or the intermediately trained machine learning algorithm may be evaluated based on a result of the comparison. In some examples, a machine learning algorithm may have parameters and hyper parameters, where the hyper parameters are set manually by a person or automatically by a process external to the machine learning algorithm (such as a hyper parameter search algorithm), and the parameters of the machine learning algorithm are set by the machine learning algorithm according to the training examples. In some implementations, the hyper-parameters are set according to the training examples and the validation examples, and the parameters are set according to the training examples and the selected hyper-parameters.

While certain steps methods are outlined herein as being executed by a specific module and other steps by another module, this should by no means be construed limiting.

It should be understood that where the claims or specification refer to “a” or “an” element, such reference is not to be construed as there being only one of that element. In the description and claims of the present application, each of the verbs, “comprise” “include” and “have”, and conjugates thereof, are used to indicate that the object or objects of the verb are not necessarily a complete listing of components, elements or parts of the subject or subjects of the verb.

While a limited number of embodiments of the invention is described herein, it will be appreciated that many variations, modifications and other applications thereof are contemplated, and therefore the invention is not limited to the specific embodiments described herein.

What is claimed is:

1. A system for authenticating a digital certificate comprising at least one processor configured to: convert a digital certificate into a non-fungible token certificate (NFTC); and to transfer the NFTC to a holder wallet of a holder named on the digital certificate.

2. The system of claim 1, wherein the at least one processor is further configured to store the NFTC in an issuer wallet before transferring the NFTC to the holder wallet, wherein the issuer wallet is held by an issuer authorized by the system to convert the digital certificate.

3. The system of claim 2, wherein the at least one processor is further configured to authorize the issuer.

4. The system of claim 1, wherein the holder wallet is one of a plurality of holder wallets, and wherein each of the plurality of holder wallets is configured to hold an NFTC of a digital certificate from a different field.

5. The system of claim 1, wherein the at least one processor is further configured to select a blockchain for recording the NFTC according to the field of the digital certificate associated with the NFTC.

6. The system of claim 1, wherein the digital certificate is an academic diploma.

7. The system of claim 6, wherein the NFTC includes one or more of the following metadata: name of teaching institution, unique identifier of the holder, major\department of graduation, or degree obtained.

8. The system of claim 1, wherein the at least one processor is further configured to provide the NFTC for viewing in the holder wallet.

9. The system of claim 1, wherein the at least one processor is further configured to provide remuneration to the holder when the NFTC is viewed or searched for.

10. The system of claim 1, wherein the at least one processor is further configured to provide a link to the NFTC in the holder wallet.

11. The system of claim 1, wherein the at least one processor is further configured to provide a marketplace for requesting, searching, issuing, and viewing of NFTCs.

12. The system of claim 1, wherein the at least one processor is further configured to provide a metaverse in which users may interact the NFTC.

13. The system of claim 1, wherein the at least one processor is further configured to submit a request for conversion of the digital certificate to the NFTC by the holder named on the digital certificate.

14. The system of claim 1, wherein the NFTC includes one or more of the following metadata: issuer name, holder name, digital certificate type, digital certificate image, certificate date of issue, certificate number, or certificate expiry date.

15. The system of claim 1, wherein the at least one processor is further configured to provide the holder with control over one or more of: who to allow to view the holder wallet, whether to enable viewers to find the holder in a search; whether to receive payment for appearing in a search; or whether to require payment for a viewer viewing the holder wallet.

16. The system of claim 4, wherein the field of the digital certificate is one of academic, patent, medical, financial, insurance, legal, trademark, or logo.

17. The system of claim 1, wherein the at least one processor is further configured to provide a user interface showing digital certificates along with an indication showing whether the digital certificates have been authenticated by conversion to NFTCs or not.

18. A non-transitory computer readable medium containing instructions that when executed by at least one processor, cause the at least one processor to perform operations comprising: converting a digital certificate into a non-fungible token certificate (NFTC); and transferring the NFTC to a holder wallet of a holder named on the digital certificate.

19. The non-transitory computer readable medium of claim 18, wherein the operations further include storing the NFTC in an issuer wallet before transferring the NFTC to the holder wallet, wherein the issuer wallet is held by an issuer authorized by the system to convert the digital certificate.

20. A method comprising: converting a digital certificate into a non-fungible token certificate (NFTC); storing the NFTC in an issuer wallet; and transferring the NFTC to a holder wallet of a holder named on the digital certificate; wherein the issuer wallet is held by an issuer authorized to convert the digital certificate.
